(19) United States
(12) Patent Application Publication
(10) Pub. No.: US 2026/0161290 A1
(43) Pub. Date: Jun. 11, 2026

(54) INTERLEAVED MIRRORING FOR A COMPUTE EXPRESS LINK COMPLIANT MEMORY DEVICE

(71) Applicant: Micron Technology, Inc., Boise, ID (US)

(72) Inventor: Ihab ELZIND, San Jose, CA (US)

(21) Appl. No.: 19/362,231

(22) Filed: Oct. 17, 2025

Related U.S. Application Data
(60) Provisional application No. 63/730,215, filed on Dec. 10, 2024.

(51) Int. Cl. G06F 3/06

(52) U.S. Cl. CPC G06F 3/061; G06F 3/0655; G06F 3/0679

(57) ABSTRACT

In some implementations, a memory system may configure a volatile memory device as a storage device. The memory system may store data to the volatile memory device. The memory system may mirror data from the volatile memory device to multiple non-volatile storage devices using an interleaving mirroring technique, wherein the interleaving mirroring technique includes distributing the data across the multiple non-volatile storage devices such that different portions of the data are mirrored to different non-volatile storage devices, of the multiple non-volatile storage devices, and wherein a respective size of each portion of the data, of the different portions of the data, corresponds to a respective cache size of a non-volatile storage device, of the different non-volatile storage devices.

### CROSS-REFERENCE TO RELATED APPLICATION

This patent application claims priority to U.S. Provisional Patent Application No. 63/730,215, filed on Dec. 10, 2024, entitled “INTERLEAVED MIRRORING FOR A COMPUTE EXPRESS LINK COMPLIANT MEMORY DEVICE,” and assigned to the assignee hereof. The disclosure of the prior application is considered part of and is incorporated by reference into this patent application.

### TECHNICAL FIELD

The present disclosure generally relates to memory devices, memory device operations, and, for example, to interleaved mirroring for a compute express link compliant memory device.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIG. 1 is a diagram illustrating an example system capable of performing interleaved mirroring for a compute express link (CXL) compliant memory device.

FIG. 2 is a diagram illustrating another example system capable of performing interleaved mirroring for a CXL compliant memory device.

FIG. 3 is a diagram of an example associated with configuring a CXL compliant memory device as a storage device.

FIG. 4 is a diagram of an example associated with an interleaving mirroring technique for a CXL memory device.

FIG. 5 shows an example memory system associated with multiple peripheral component interconnect express (PCIe) root complexes that may use a CXL device as a storage device.

FIG. 6 is a flowchart of an example method associated with interleaved mirroring for a CXL compliant memory device.

### DETAILED DESCRIPTION

The rapid evolution of computing systems has led to a persistent challenge in balancing the performance of volatile memory, such as static random access memory (SRAM) and dynamic RAM (DRAM), with the data retention capabilities of non-volatile memory, like flash and magnetic storage media. In modern computing environments, volatile memory offers high performance but loses data when power is removed, while non-volatile memory maintains data persistently but often at the cost of significantly reduced performance. To address this, systems architects have traditionally employed volatile memory as cache, which is then flushed to persistent media in the background, aiming to improve speed and performance. However, this approach can introduce a window of data loss (e.g., if power is lost prior to flushing the data cached in the volatile memory to persistent media) and thus typically requires additional mechanisms to mitigate risk, such as backup power or frequent flushing, which can compromise system efficiency.

Moreover, the industry's drive toward higher speed and lower latency access to data has led to the use of RAM-disks, which allocate a portion of an operating system's memory to function as a high-speed disk drive. While this solution can improve disk access times for certain use cases, it presents its own set of problems. Utilizing significant amounts of system memory for a RAM-disk can limit resources available to the operating system, potentially impacting overall system performance. Additionally, the data stored on a RAM-disk is volatile and lost upon system reboot, posing a challenge for data persistency.

Some implementations described herein provide a memory system that effectively combines the high performance of volatile memory with the data retention capabilities of non-volatile memory. Specifically, the system includes one or more components configured to configure a CXL compliant memory device as a storage device, store data to this device, and employ an interleaving mirroring technique to mirror the data from the CXL compliant memory device to multiple non-volatile storage devices.

In some aspects, the interleaving mirroring technique involves distributing the data across the multiple non-volatile storage devices such that different portions of the data are mirrored to different devices. This distribution mitigates the risk of data loss and improves data recovery times. The system may include a training operation to determine an optimal interleaving pattern for the mirroring technique, enhancing the efficiency of data mirroring and access. Additionally, the system may adjust the size of data blocks being mirrored based on the buffer capacity of each non-volatile storage device, optimizing storage utilization.

Furthermore, different portions of the data may be allocated to different non-volatile storage devices based on their respective data transfer rates, which allows for a more efficient data read/write process and reduces the time required for system recovery operations. In some implementations, upon booting up the CXL compliant memory device, data can be copied from the multiple non-volatile storage devices back to the CXL compliant memory device, ensuring that the system is quickly ready for operation with the latest data set.

In this way, the memory system not only ensures high-speed data access akin to volatile memory but also maintains data persistence through mirroring to non-volatile storage devices. The interleaving mirroring technique allows for a more efficient use of multiple non-volatile storage devices, thereby conserving processing resources and memory resources. By optimizing the mirroring process and the data allocation strategy, the system minimizes the performance penalty typically associated with data mirroring. Consequently, the memory system achieves an improved balance between memory performance and data retention, which in turn may conserve processing resources, memory resources, network resources, and/or the like. This optimization leads to a memory system that supports the reliability and efficiency of computing environments without significant trade-offs.

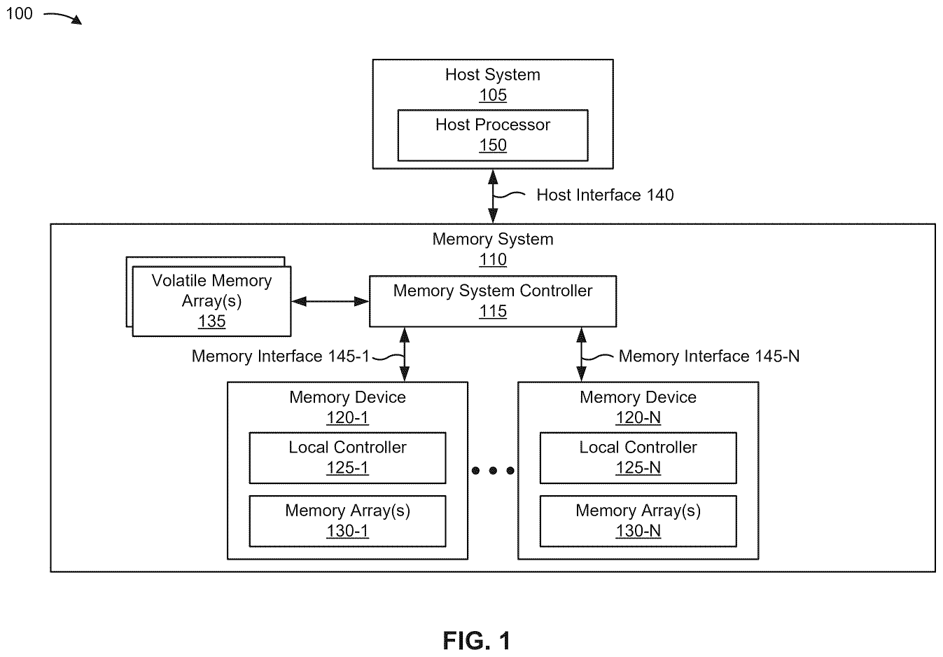

FIG. 1 is a diagram illustrating an example system 100 capable of performing interleaved mirroring for a CXL compliant memory device. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

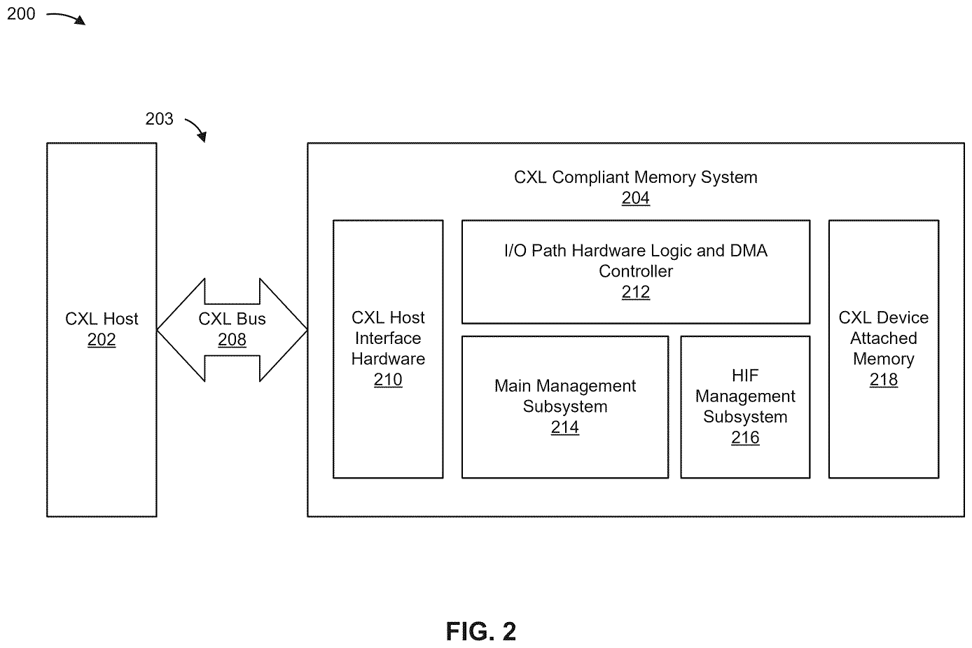

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to configure a volatile memory device as a storage device; store data to the volatile memory device; and mirror data from the volatile memory device to multiple non-volatile storage devices using an interleaving mirroring technique, wherein the interleaving mirroring technique includes distributing the data across the multiple non-volatile storage devices such that different portions of the data are mirrored to different non-volatile storage devices, of the multiple non-volatile storage devices, and wherein a respective size of each portion of the data, of the different portions of the data, corresponds to a respective cache size of a non-volatile storage device, of the different non-volatile storage devices.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of performing interleaved mirroring for a CXL compliant memory device. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system, a CXL memory system, a CXL compliant memory device, and/or a CXL compliant memory device). In that regard, the system 200 may include a CXL host 202 (which may correspond to the host system 105) and a CXL compliant memory system 204 (which may correspond to the memory system 110 and/or which may be referred to as a CXL compliant memory device, which is a volatile memory device that complies with the CXL standard and/or protocol, as described in more detail below). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 (e.g., CXL compliant memory device) may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

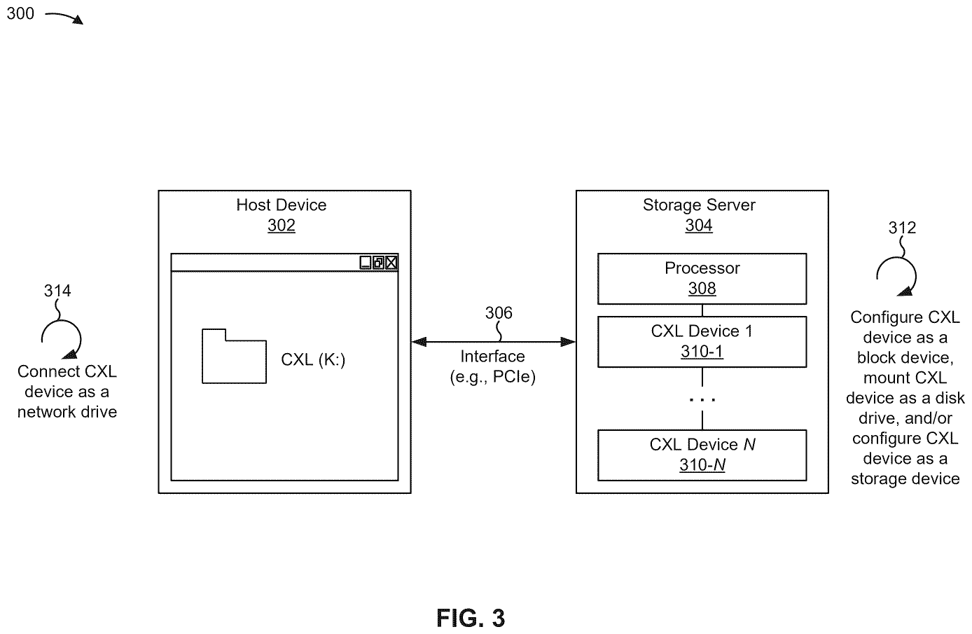

FIG. 3 is a diagram of an example 300 associated with configuring a CXL compliant memory device as a storage device. As shown in FIG. 3, example 300 may include a host device 302 and a storage server 304 (as one example of a memory system). The host device 302 and the storage server 304 may be operatively connected and/or in communication with each other via an interface 306, which may be a PCIe interface or a similar interface. In some implementations, the host device 302 may correspond to the host system 105 and/or the CXL host 202, the storage server 304 may correspond to the memory system 110 and/or the CXL compliant memory system 204 and/or may include one or more components of the memory system 110 and/or the CXL compliant memory system 204, and/or the interface 306 may correspond to the host interface 140 and/or the CXL bus 208.

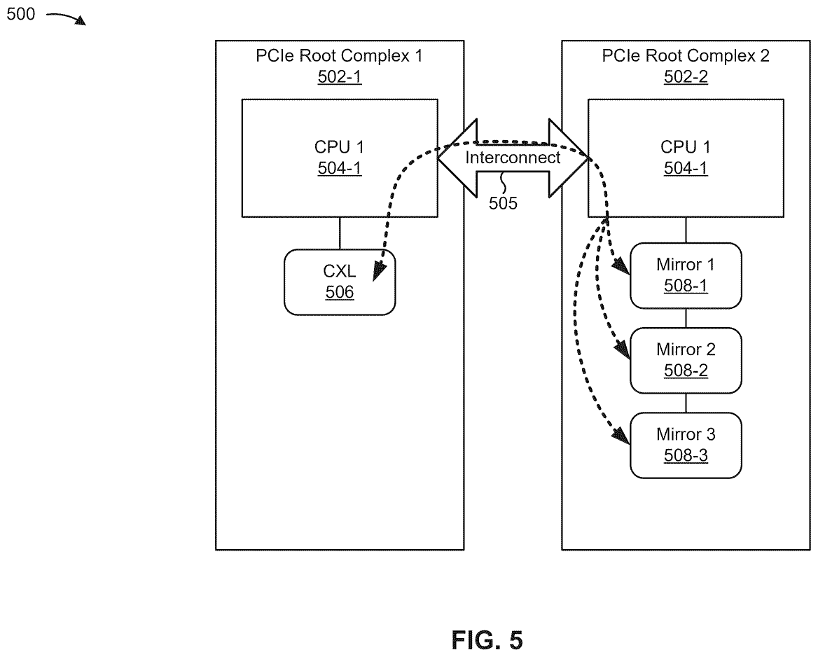

As further shown in FIG. 3, the storage server 304 may include a processor 308 (e.g., a CPU) and one or more memory devices, such as one or more CXL devices 310 (e.g., one or more CXL compliant memory devices, shown in FIG. 3A as a first CXL device 310-1 through an N^{th} CXL device 310-N, but which may include only a single CXL device 310 in some other implementations). The processor 308 may be operatively connected to and/or in communication with the CXL device 310 via an interface, such as via a PCIe bus associated with a PCIe root complex or similar interface, which is described in more detail below in connection with FIG. 5. In some implementations, the processor 308 may be capable of managing data flow in the storage server 304 (e.g., to and from the CXL devices 310), executing tasks for the storage server 304, and/or optimizing performance of the storage server 304, such as by handling data storage tasks, retrieval tasks, management tasks, and/or security tasks, among other examples. In some implementations, the processor 308 may ensure efficient operation and reliable performance of the storage server 304, such as by balancing resource loads and managing network communications. In some implementations, the processor may correspond to the memory system controller 115 described above in connection with FIG. 1.

In some implementations, the CXL devices 310 may be initialized, configured, and/or otherwise setup to be used as storage devices (e.g., to be used for long-term data storage, such as for a purpose of storing information associated with one or more operating systems, applications, user files, and/or similar data). For example, the CXL devices 310 may be initialized, configured, and/or otherwise setup to be used as storage devices that store user data associated with one or more client devices (e.g., host device 302 and/or similar devices and/or systems). In this way, the host device 302 may take advantage of the high-performance attributes of a CXL device 310 (e.g., high speed and/or low latency) when storing and accessing data. Put another way, because, in some implementations, a CXL device 310 may be a self-contained memory module that is associated with a static size, a same form factor as traditional storage devices (e.g., SSD devices, flash devices, and/or similar devices), high capacity, and scalability, the CXL device 310 may serve as a high-performance storage device, such as when implemented within the storage server 304 and/or in similar applications.

In some implementations, and as indicated by reference number 312, in order for the CXL devices 310 to serve as a storage device, the CXL devices 310 may be configured as block devices, may be mounted on a mount point as a disk drive, and/or may otherwise be configured to be used as a storage device. For example, each CXL device 310 may be represented to a basic input/output system (BIOS) associated with the processor 308, an operating system (OS) associated with the processor 308, and/or a similar component associated with the processor 308, as a storage block device on a PCIe root complex, among other examples. For example, in some implementations, the processor 308 may be associated with a Linux virtual machine (VM) running an Ubuntu OS, among other examples. In such examples, the CXL device 310 may be configured as a/dev/pmem device file (e.g., a device file traditionally associated with a persistent memory and/or non-volatile memory, such as an NVMe SSD drive or a similar storage device), among other examples.

As indicated by reference number 314, once configured as a storage device, the CXL device 310 may be connected to the host device 302 as a network drive (e.g., such as a network drive indicated by “K:” in the example shown in FIG. 3). For example, in some implementations the CXL device 310 may be connected to the host device 302 as a network drive using one or more of a common Internet file system (CIFS) protocol, a network file system (NFS) protocol, an Internet small computer systems interface (ISCSI) protocol, and/or a similar protocol. For example, in some implementations, such as examples in which the processor 308 is associated with a Linux VM running an Ubuntu OS, the CXL device 310 may be configured as an ISCSI target (ISCSI TGT) (e.g., a storage resource located on an ISCSI server made available to ISCSI initiators (e.g., clients, such as host device 302) over a network). For example, in some implementations, the CXL device 310 may be configured as a storage CXL target using ISCSI TGT, among other examples. Then, the host device 302 (which may, in some examples, may be a device associated with a Windows OS) may mount the storage CXL target as a disk drive and/or may format the disk drive to connect to the host device 302, such as drive “K:” in the example shown in FIG. 3.

In implementations in which the one or more CXL devices 310 are configured as a storage device, such as in the manner described above, the CXL devices 310 may exhibit increased performance as compared to traditional storage devices (e.g., flash storage devices, NVMe SSDs, and/or similar devices), but may pose a drawback in that the memory is not persistent. In that regard, if a power source is removed from the CXL devices 310 and/or the storage server 304, user data stored at the CXL devices 310 may be lost.

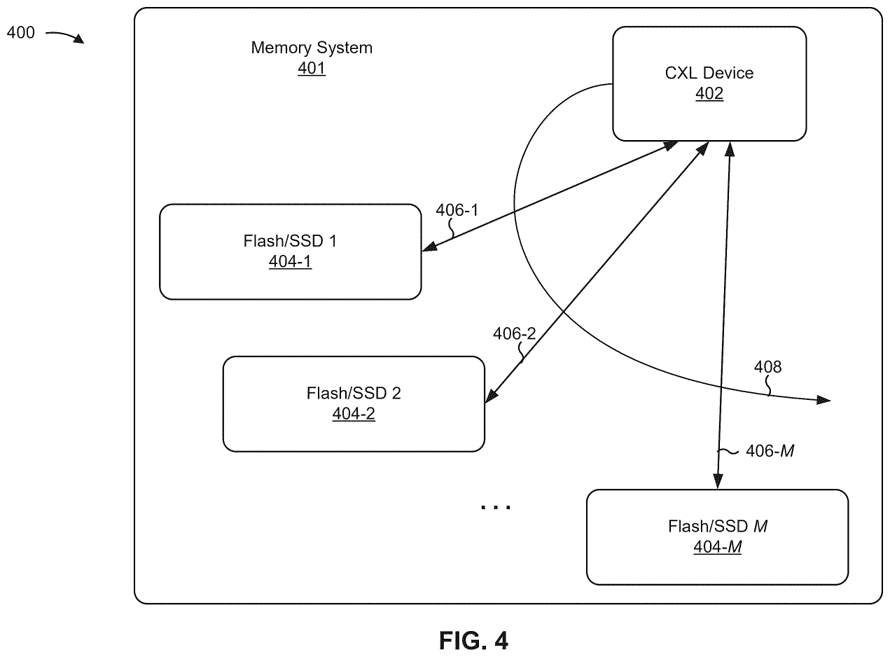

Accordingly, in some implementations, when a CXL device 310 is configured to be used as a storage device (e.g., in the manner described above), the storage server 304 (more particularly, the processor 308 thereof and/or a software driver associated with the processor 308, a BIOS associated with the processor 308, and/or a similar component associated with the processor 308 that is configured to control operations at the CXL device 310) may support mirroring of data stored at the CXL device 310 to persistent memory, such as one or more non-volatile storage devices. For example, in some implementations, in order to avoid performance loss that might result from mirroring a relatively fast CXL device 310 to a relatively slow non-volatile storage device (e.g., an NVMe SSD, a flash storage device, and/or a similar non-volatile storage device) using a one-to-one mirroring scheme (e.g., a scheme in which a single CXL device is mirrored to a single non-volatile storage device), the memory system may support a one-to-many mirroring scheme, sometimes referred to herein as an interleaving mirroring technique. In the interleaving mirroring technique, data stored at a CXL device 310 is split in portions (sometimes referred to herein as striping blocks) and stripped across multiple non-volatile memory devices. In such examples, a dwell time associated with each of the multiple non-volatile memory devices may be minimized, to avoid cache write penalties associated with the interleaving mirroring technique. Aspects of the interleaving mirroring technique are described in more detail below in connection with FIG. 4.

As indicated above, FIG. 3 is provided as an example. Other examples may differ from what is described with regard to FIG. 3. The number and arrangement of components shown in FIG. 3 are provided as an example. In practice, there may be additional components, fewer components, different components, or differently arranged components than those shown in FIG. 3.

FIG. 4 is a diagram of an example 400 associated with an interleaving mirroring technique for a CXL memory device. As shown in FIG. 4, the example 400 may be associated with a memory system 401 including a CXL device 402 (which may correspond to the CXL device 310) and multiple (e.g., M) non-volatile storage devices 404 (shown in FIG. 4 as a first non-volatile storage device 404-1 through an M^{th} non-volatile storage device 404-M), among other components not shown in FIG. 4 for ease of description (e.g., a processor and/or CPU, among other examples). In some implementations, the non-volatile storage devices 404 may be flash storage devices (e.g., non-volatile storage devices that utilize flash memory technology based on electronically erasable programmable read-only memory (EEPROM)), SSDs (e.g., NVMe SSDs), and/or similar storage devices.

As shown in FIG. 4, the CXL device 402 may be associated with a respective mirroring path 406 for each non-volatile storage device 404, such as a first mirroring path 406-1 associated with the first non-volatile storage device 404-1, a second mirroring path 406-2 associated with the second non-volatile storage device 404-2, and so forth through an M^{th} mirroring path 406-M associated with the M^{th} non-volatile storage device 404-M. In some implementations, the mirroring paths 406 may be associated with one or more interfaces (e.g., PCIe interfaces and/or buses), interconnects, and/or components configured to enable data transfer from the CXL device 402 to the non-volatile storage devices 404. For example, as described in more detail below in connection with FIG. 5, in some implementations the CXL device 402 may be associated with a first PCIe root complex and the M non-volatile storage devices 404 may be associated with a second PCIe root complex. In such implementations, the mirroring paths 406 may include one or more PCIe busses associated with each PCIe root complex and/or one or more processors configured to enable communication between the PCIe root complexes, among other examples.

In some implementations, the mirroring paths 406 may enable mirroring of data stored at the CXL device 402 to the multiple non-volatile storage devices 404. For example, the memory system 401 (more particularly, a processor of the memory system 401 (e.g., processor 308) and/or a component of the processor (e.g., a BIOS associated with the CXL device 402 and/or a software driver associated with the CXL device 402)) may be capable of mirroring data stored at the CXL device 402 (e.g., data stored at the CXL device 402 based on using the CXL device 402 as a storage device, as described above in connection with FIG. 3) to the multiple non-volatile storage devices 404, such as by splitting the data and striping the data across the non-volatile storage devices 404. More particularly, the memory system 401 may be capable of mirroring a first portion (e.g., a first striping block) of data stored at the CXL device 402 to the first non-volatile storage device 404-1 using the first mirroring path 406-1, mirroring a second portion of data (e.g., a different portion than the first portion of the data) stored at the CXL device 402 to the second non-volatile storage device 404-1 using the second mirroring path 406-2, and so forth through mirroring an M^{th} portion of the data stored at the CXL device 402 to the M^{th} non-volatile storage device 404-M using the M^{th} mirroring path 406-M. In such implementations, a performance loss otherwise associated with mirroring fast memory (e.g., the CXL device 402) to a slow storage device (e.g., a single one of the non-volatile storage devices 404) may be avoided, which is described in more detail below.

In some implementations, the memory system 401 may be capable of optimizing mirroring operations at the non-volatile storage device. For example, in some implementations, the BIOS, a software driver, or a similar component of the memory system 401 may be capable of minimizing dwell times associated with each non-volatile storage device 404, such as for a purpose of avoiding cache write penalties associated with the interleaved mirroring technique (e.g., to avoid delays associated with mirroring the data to the non-volatile storage devices 404). A “dwell time” is a time associated with writing portions of the data to the non-volatile storage devices 404, which may correspond to, for each non-volatile storage device 404, a buffer size associated with the non-volatile storage device 404 divided by an effective link speed for the non-volatile storage device 404.

For example, in some implementations, a non-volatile storage device 404 may be associated with a non-volatile storage device (e.g., an SSD) that includes a volatile memory component (e.g., DRAM) to cache frequently accessed data (and thus which is sometimes referred to as a DRAM SSD), such as for a purpose of improving performance at the SSD (e.g., caching data using the DRAM may lead to faster read and write times for the SSD). In such implementations, the memory system 401 may spread the mirrored data across the non-volatile storage devices such that the mirrored data is written into DRAM at each non-volatile storage device 404 (and later flushed into non-volatile memory, such as NAND memory) during the mirroring process to avoid cache write penalties, among other examples.

More particularly, as shown in FIG. 4, and as schematically indicated using arrow 408, an interleaving mirroring technique may involve mirroring a first portion of the data stored at the CXL device 402 to the first non-volatile storage device 404-1, then mirroring a second portion of the data stored at the CXL device 402 to the second non-volatile storage device 404-2, and so forth through mirroring an M^{th} portion of the data stored at the CXL device 402 to the M^{th} non-volatile storage device 404-M. After mirroring the M^{th} portion of the data stored at the CXL device 402 to the M^{th} non-volatile storage device 404-M, the interleaving mirroring technique may include returning to the first non-volatile storage device 404-1, such that an M+1^{th} portion of the data is mirrored to the first non-volatile storage device 404-1, an M+2^{th} portion of the data is mirrored to the second non-volatile storage device 404-2, and so forth. In this way, the non-volatile storage devices 404 may be able to cache the mirrored data in DRAM and then flush the data to NAND before receiving a next portion of the mirrored data. In such examples, for non-volatile storage devices 404 that are approximately 1/X as fast as the CXL device 402, X non-volatile storage devices 404 may be used for the interleaving mirroring process in order to avoid a cache write penalty and otherwise not hamper the performance improvements of using the CXL device 402 as the storage device. For example, if the CXL device 402 is approximately three times faster than each non-volatile storage device 404, three non-volatile storage devices 404 (e.g., three SSDs or three flash arrays) may be used to mirror the CXL device 402.

In some implementations, the memory system 401 may be capable of performing a training process on the non-volatile storage devices 404, such as for a purpose of identifying a size of a cache memory at each non-volatile storage device 404. For example, for each non-volatile storage device 404, the memory system 401 may determine the size of the cache memory at that non-volatile storage device 40 and set a size of a striping block to be used for that non-volatile storage device 404 to the size of the cache memory. More particularly, the memory system 401 may conduct a training process to identify a size of cache associated with each non-volatile storage device 404 and to compute a corresponding cache-block size (e.g., striping block size) to use for each non-volatile storage device 404 based on the corresponding cache size, thereby enabling the performance of the multiple non-volatile storage devices 404 to collectively match the performance of the CXL device 402. In some implementations, the memory system 401 may adjust the size of data blocks being mirrored based on the buffer capacity of each non-volatile storage device 404 and/or may allocate data portions based on respective data transfer rates of the non-volatile storage devices, among other examples.

In some implementations, a cache at each non-volatile storage device 404 may be protected by a power loss circuit or similar power loss protection component. For example, a size of a cache at a non-volatile storage device 404 may be set such that a power loss circuit associated with the non-volatile storage device 404 provides enough electric power to the non-volatile storage device 404 to write any data stored in the cache to non-volatile storage (e.g., flash memory) in the event of a power loss. In such implementations, identifying a corresponding cache-block size (e.g., striping block size) to use for each non-volatile storage device 404 based on the corresponding cache size may ensure that no data being mirrored to the non-volatile storage devices 404 is lost in the event of a power loss. Put another way, optimizing the cache-block size in the manner described above enables utilization of inherent electric power loss protection built in the non-volatile storage devices 404.

Because the CXL device 402 is associated with volatile memory, if power is lost and/or removed from the CXL device 402, any data stored thereon may be lost. Accordingly, in some implementations, the memory system 401 may be capable of restoring data to the CXL device 402, such as during a boot sequence of the CXL device. For example, the memory system 401 may be capable of copying data stored at the multiple non-volatile storage devices 404 (e.g., user data that was previously mirrored to the non-volatile storage devices 404 from the CXL device 402) to the CXL device 402 when the CXL device 402 is booted up, power cycled, or otherwise initialized following a powering-on event, or the like. Put another way, upon startup of the CXL device 402, the processor may copy data back from the multiple non-volatile storage devices 404 to the CXL device 402 in order to ensure data persistence at the otherwise volatile memory.

In some aspects, a memory system employing a CXL device 402 as a storage device may be associated with multiple PCIe root complexes, with the CXL device 402 linked to a first PCIe root complex and the multiple non-volatile storage devices 404 linked to a second PCIe root complex. This will be described in more detail below, in connection with FIG. 5.

As indicated above, FIG. 4 is provided as an example. Other examples may differ from what is described with regard to FIG. 4. The number and arrangement of components shown in FIG. 4 are provided as an example. In practice, there may be additional components, fewer components, different components, or differently arranged components than those shown in FIG. 4.

FIG. 5 shows an example memory system 500 associated with multiple PCIe root complexes that may use a CXL device as a storage device. More particularly, as shown in FIG. 5, the memory system may include two PCIe root complexes 502, shown in FIG. 5 as a first PCIe root complex 502-1 and a second PCIe root complex 502-2. The memory system 500 may be associated with a dual-CPU configuration, in which each PCIe root complex 502 is associated with a corresponding CPU 504 (shown in FIG. 5 as a first CPU 504-1 and a second CPU 504-2, respectively). However, in some other implementations, the memory system may be associated with a single CPU 504 (e.g., each PCIe root complex 502 may be associated with the same CPU 504). In implementations associated with a dual-CPU configuration, the CPUs 504 may be operatively coupled and/or in communication with one another via an interconnect 505.

The memory system 500 may be associated with a CXL device 506 that is configured as a storage device, and thus which may correspond to the CXL device 310 and/or the CXL device 402, described above. The memory system 500 may further include multiple mirror devices 508, shown in FIG. 5 as a first mirror device 508-1 through a third mirror device 508-3 (but which may include more or fewer mirror devices 508 in other implementations). The mirror devices 508 may be used to mirror data stored on the CXL device 506, such as via an interleaving mirroring technique (e.g., the interleaving mirroring technique described above in connection with FIG. 4). In that regard, the mirror devices 508 may be non-volatile storage devices (e.g., flash storage devices, SSDs, NVMe SSDs, and/or similar devices), and/or the mirror devices 508 may correspond to the non-volatile storage devices 404 described above in connection with FIG. 4.

As shown in FIG. 5, the CXL device 506 may be associated with (e.g., may sit on and/or may otherwise be linked to) the first PCIe root complex 502-1, and the mirror devices 508 may be associated with (e.g., may sit on and/or may otherwise be linked to) the second PCIe root complex 502-2. In such implementations, the one or more CPUs 504 may utilize the second PCIe root complex 502-2 to mirror the data stored at the first PCIe root complex 502-1 (e.g., stored at the CXL device 506 of the first PCIe root complex 502-1). Put another way, as shown in FIG. 5 using a dashed-line arrow, data stored at the CXL device 506 on the first PCIe root complex 502-1 may be mirrored to the multiple mirror devices 508 on the second PCIe root complex 502-2, such as by using the interleaving mirroring technique described above in connection with FIG. 4.

In some implementations, the memory system 500 may utilize DMA channels for performing the mirroring operations described herein (e.g., for copying data from the CXL device 506 to the multiple mirror devices 508, among other examples). Put another way, in implementations in which the CXL device 506 sits on the first PCIe root complex 502-1, the memory system 500 may use the second PCIe root complex 502-2 to mirror the data from the CXL device 506 (e.g., by using the interleaving mirroring technique to copy the data to the multiple mirror devices 508) by utilizing DMA channels to offload data storage at the CPUs 504, among other examples.

As indicated above, FIG. 5 is provided as an example. Other examples may differ from what is described with regard to FIG. 5. The number and arrangement of components shown in FIG. 5 are provided as an example. In practice, there may be additional components, fewer components, different components, or differently arranged components than those shown in FIG. 5.

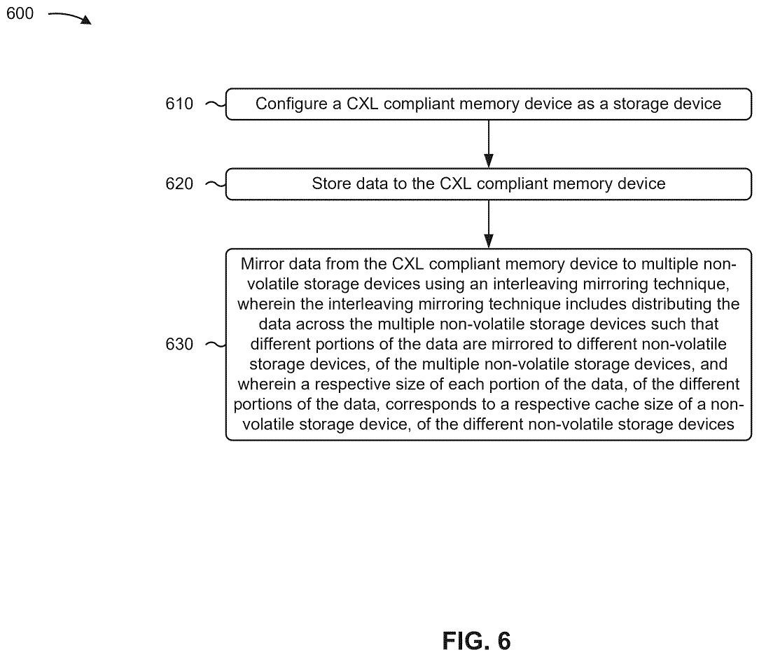

FIG. 6 is a flowchart of an example method 600 associated with interleaved mirroring for a compute express link compliant memory device. In some implementations, a memory system (e.g., the memory system 110, the CXL compliant memory system 204, the storage server 304, the memory system 401, and/or the memory system 500) may perform or may be configured to perform the method 600. In some implementations, another device or a group of devices separate from or including the memory system (e.g., host system 105, CXL host 202, and/or host device 302) may perform or may be configured to perform the method 600. Additionally, or alternatively, one or more components of the memory system (e.g., memory controller 115, local controller 125, I/O path hardware logic and DMA controller, main management subsystem 214, processor 308, CXL device 310, CXL device 402, one or more non-volatile storage devices 404, one or more CPUs 504, CXL device 506, and/or one or more mirror devices 508) may perform or may be configured to perform the method 600. Thus, means for performing the method 600 may include the memory system and/or one or more components of the memory system. Additionally, or alternatively, a non-transitory computer-readable medium may store one or more instructions that, when executed by the memory system, cause the memory system to perform the method 600.

As shown in FIG. 6, the method 600 may include configuring a volatile memory device as a storage device (block 610). For example, in a similar manner as described above in connection with FIG. 3, the CXL device 310 (as one example of a volatile memory device) may be configured as a storage device, such that the CXL device 310 is available as a network drive on the host device 302, among other examples.

As further shown in FIG. 6, the method 600 may include storing data to the volatile memory device (block 620). For example, in a similar manner as described above in connection with FIGS. 3-5, user data and/or host data may be stored to one of the CXL devices 310, 402, or 506 when the CXL device is configured as a storage device.

As further shown in FIG. 6, the method 600 may include mirroring data from the volatile memory device to multiple non-volatile storage devices using an interleaving mirroring technique, wherein the interleaving mirroring technique includes distributing the data across the multiple non-volatile storage devices such that different portions of the data are mirrored to different non-volatile storage devices, of the multiple non-volatile storage devices, and wherein a respective size of each portion of the data, of the different portions of the data, corresponds to a respective cache size of a non-volatile storage device, of the different non-volatile storage devices (block 630). For example, in a similar manner as described above in connection with FIGS. 4 and 5, data stored on a CXL device 402, 506 may be mirrored to multiple non-volatile storage devices (e.g., non-volatile storage devices 404 and/or mirror devices 508) using an interleaving mirroring technique (e.g., by striping the data across the multiple non-volatile storage devices) with portions of the data being stored on each non-volatile storage device corresponding to a cache size associated with that non-volatile storage device, such as for a purpose of ensuring data persistency for the CXL device 402, 506 being used as a storage device.

The method 600 may include additional aspects, such as any single aspect or any combination of aspects described below and/or described in connection with one or more other methods or operations described elsewhere herein.

In a first aspect, the volatile memory device is a CXL compliant memory device, and configuring the volatile memory device as the storage device includes representing the CXL compliant memory device as a storage block device on a peripheral component interconnect express root complex. For example, in a similar manner as described above in connection with FIGS. 3 and 5, a CXL device 310, 506 may be represented on a PCIe root complex (e.g., the first PCIe root complex 502-1) as a storage device.

In a second aspect, alone or in combination with the first aspect, the method 600 includes performing a training operation to determine an optimal interleaving pattern associated with the interleaving mirroring technique. For example, in a similar manner as described above in connection with FIG. 4, the memory system 401 may perform a training operation to determine cache sizes associated with the non-volatile storage devices 404 and/or to set striping block sizes to the determined cache sizes, such as for a purpose of avoiding a cache write penalty associated with mirroring the data to the non-volatile storage devices 404.

In a third aspect, alone or in combination with one or more of the first and second aspects, determining the optimal interleaving pattern includes, for each non-volatile storage device, of the multiple non-volatile storage devices determining an optimal size of a cache memory for that non-volatile storage device, and configuring a block size for that non-volatile storage device such that the block size is equal to the optimal size of the cache memory. For example, in a similar manner as described above in connection with FIG. 4, the memory system 401 may perform a training operation to determine cache sizes associated with the non-volatile storage devices 404 and/or to set striping block sizes to the determined cache sizes, such as for a purpose of avoiding a cache write penalty associated with mirroring the data to the non-volatile storage devices 404.

In a fourth aspect, alone or in combination with one or more of the first through third aspects, the method 600 includes adjusting a size of data blocks being mirrored to each non-volatile storage device, of the multiple non-volatile storage devices, based on a buffer capacity of that non-volatile storage device. For example, in a similar manner as described above in connection with FIG. 4, the memory system 401 may adjust striping block sizes associated with each non-volatile storage device 404 to match respective buffer (e.g., DRAM) capacities associated with each non-volatile storage device 404, such as for a purpose of optimizing the interleaving mirroring technique.

In a fifth aspect, alone or in combination with one or more of the first through fourth aspects, the method 600 includes allocating the different portions of the data to the different non-volatile storage devices based on respective data transfer rates associated with the different non-volatile storage devices. For example, in a similar manner as described above in connection with FIG. 4, the memory system 401 may allocate portions of the data to each non-volatile storage device 404 based on data transfer rates associated with each non-volatile storage device 404, such as for a purpose of minimizing dwell times associated with the non-volatile storage devices 404.

In a sixth aspect, alone or in combination with one or more of the first through fifth aspects, the method 600 includes copying the data from the multiple non-volatile storage devices to the volatile memory device based on booting up the volatile memory device. For example, in a similar manner as described above in connection with FIG. 4, upon booting up and/or power cycling a mirrored CXL device 402, the memory system 401 may initialize the CXL device 402 by copying mirrored data from the non-volatile storage devices 404 back to the CXL device 402.

In a seventh aspect, alone or in combination with one or more of the first through sixth aspects, the memory system is associated with at least two PCIe root complexes, the volatile memory device is associated with a first PCIe root complex, of the at least two PCIe root complexes, and the multiple non-volatile storage devices are associated with a second PCIe root complex, of the at least two PCIe root complexes. For example, in a similar manner as described above in connection with FIG. 5, the CXL device 506 may be associated with the first PCIe root complex 502-1 of the memory system 500, and the mirror devices 508-2 may be associated with the second PCIe root complex 502-2 of the memory system 500.

In an eighth aspect, alone or in combination with one or more of the first through seventh aspects, mirroring the data from the volatile memory device to the multiple non-volatile storage devices includes utilizing DMA channels for mirroring the data from the volatile memory device to the multiple non-volatile storage devices. For example, in a similar manner as described above in connection with FIG. 4, the memory system may utilize DMA channels to offload data storage at the one or more CPUs 504 when mirroring data from the first PCIe root complex 502-1 (e.g., from the CXL device 506 sitting on the first PCIe root complex 502-1) to the second PCIe root complex 502-2 (e.g., to the mirror devices 508 sitting on the second PCIe root complex 502-2).

In a ninth aspect, alone or in combination with one or more of the first through eighth aspects, the multiple non-volatile storage devices are solid-state drives. For example, in a similar manner as described above in connection with FIGS. 4-5, the non-volatile storage devices 404 and/or mirror devices 508 may be SSDs, such as NVMe SSDs, among other examples.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a memory system includes one or more components configured to: configure, as a storage device, a volatile memory device associated with the memory system; store data to the volatile memory device; and mirror, using an interleaving mirroring technique, the data from the volatile memory device to multiple non-volatile storage devices associated with the memory system, wherein the interleaving mirroring technique includes distributing the data across the multiple non-volatile storage devices such that different portions of the data are mirrored to different non-volatile storage devices, of the multiple non-volatile storage devices, and wherein a respective size of each portion of the data, of the different portions of the data, corresponds to a respective cache size of a non-volatile storage device, of the different non-volatile storage devices.

In some implementations, a method comprising: configuring, by a memory system, a volatile memory device as a storage device; storing, by the memory system, data to the volatile memory device; and mirroring, by the memory system, data from the volatile memory device to multiple non-volatile storage devices using an interleaving mirroring technique, wherein the interleaving mirroring technique includes distributing the data across the multiple non-volatile storage devices such that different portions of the data are mirrored to different non-volatile storage devices, of the multiple non-volatile storage devices, and wherein a respective size of each portion of the data, of the different portions of the data, corresponds to a respective cache size of a non-volatile storage device, of the different non-volatile storage devices.

In some implementations, a non-transitory computer-readable medium storing a set of instructions includes one or more instructions that, when executed by one or more processors of a memory system, cause the memory system to: configure a volatile memory device as a storage device; store data to the volatile memory device; and mirror data from the volatile memory device to multiple non-volatile storage devices using an interleaving mirroring technique, wherein the interleaving mirroring technique includes distributing the data across the multiple non-volatile storage devices such that different portions of the data are mirrored to different non-volatile storage devices, of the multiple non-volatile storage devices, and wherein a respective size of each portion of the data, of the different portions of the data, corresponds to a respective cache size of a non-volatile storage device, of the different non-volatile storage devices.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the term “approximately” means “within reasonable tolerances of manufacturing and measurement.”

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
configure, as a storage device, a volatile memory device associated with the memory system;
store data to the volatile memory device; and
mirror, using an interleaving mirroring technique, the data from the volatile memory device to multiple non-volatile storage devices associated with the memory system,
wherein the interleaving mirroring technique includes distributing the data across the multiple non-volatile storage devices such that different portions of the data are mirrored to different non-volatile storage devices, of the multiple non-volatile storage devices, and
wherein a respective size of each portion of the data, of the different portions of the data, corresponds to a respective cache size of a non-volatile storage device, of the different non-volatile storage devices.

2. The memory system of claim 1, wherein the volatile memory device is a compute express link (CXL) compliant memory device, and
wherein the one or more components, to configure the volatile memory device as the storage device, are configured to represent the CXL compliant memory device as a storage block device on a peripheral component interconnect express root complex.

3. The memory system of claim 1, wherein the one or more components are further configured to perform a training operation to determine an optimal interleaving pattern associated with the interleaving mirroring technique.

4. The memory system of claim 3, wherein the one or more components, to determine the optimal interleaving pattern, are configured to, for each non-volatile storage device, of the multiple non-volatile storage devices:
determine an optimal size of a cache memory for that non-volatile storage device; and
configure a block size for that non-volatile storage device such that the block size is equal to the optimal size of the cache memory.

5. The memory system of claim 1, wherein the one or more components are further configured to adjust a size of data blocks being mirrored to each non-volatile storage device, of the multiple non-volatile storage devices, based on a buffer capacity of that non-volatile storage device.

6. The memory system of claim 1, wherein the one or more components are further configured to allocate the different portions of the data to the different non-volatile storage devices based on respective data transfer rates associated with the different non-volatile storage devices.

7. The memory system of claim 1, wherein the one or more components are further configured to copy the data from the multiple non-volatile storage devices to the volatile memory device based on booting up the volatile memory device.

8. The memory system of claim 1, wherein the memory system is associated with at least two peripheral component interconnect express (PCIe) root complexes,
wherein the volatile memory device is associated with a first PCIe root complex, of the at least two PCIe root complexes, and
wherein the multiple non-volatile storage devices are associated with a second PCIe root complex, of the at least two PCIe root complexes.

9. The memory system of claim 1, wherein the one or more components, to mirror the data from the volatile memory device to the multiple non-volatile storage devices, are further configured to utilize direct memory access (DMA) channels for mirroring the data from the volatile memory device to the multiple non-volatile storage devices.

10. The memory system of claim 1, wherein the multiple non-volatile storage devices are solid-state drives.

11. A method comprising:
configuring, by a memory system, a volatile memory device as a storage device;
storing, by the memory system, data to the volatile memory device; and
mirroring, by the memory system, data from the volatile memory device to multiple non-volatile storage devices using an interleaving mirroring technique,
wherein the interleaving mirroring technique includes distributing the data across the multiple non-volatile storage devices such that different portions of the data are mirrored to different non-volatile storage devices, of the multiple non-volatile storage devices, and
wherein a respective size of each portion of the data, of the different portions of the data, corresponds to a respective cache size of a non-volatile storage device, of the different non-volatile storage devices.

12. The method of claim 11, wherein the volatile memory device is a compute express link (CXL) compliant memory device, and
wherein configuring the volatile memory device as the storage device includes representing the CXL compliant memory device as a storage block device on a peripheral component interconnect express root complex.

13. The method of claim 11, further comprising performing a training operation to determine an optimal interleaving pattern associated with the interleaving mirroring technique.

14. The method of claim 13, wherein determining the optimal interleaving pattern includes, for each non-volatile storage device, of the multiple non-volatile storage devices:
determining an optimal size of a cache memory for that non-volatile storage device; and
configuring a block size for that non-volatile storage device such that the block size is equal to the optimal size of the cache memory.

15. The method of claim 11, further comprising adjusting a size of data blocks being mirrored to each non-volatile storage device, of the multiple non-volatile storage devices, based on a buffer capacity of that non-volatile storage device.

16. The method of claim 11, further comprising allocating the different portions of the data to the different non-volatile storage devices based on respective data transfer rates associated with the different non-volatile storage devices.

17. The method of claim 11, further comprising copying the data from the multiple non-volatile storage devices to the volatile memory device based on booting up the volatile memory device.

18. The method of claim 11, wherein the memory system is associated with at least two peripheral component interconnect express (PCIe) root complexes,
wherein the volatile memory device is associated with a first PCIe root complex, of the at least two PCIe root complexes, and
wherein the multiple non-volatile storage devices are associated with a second PCIe root complex, of the at least two PCIe root complexes.

19. The method of claim 11, wherein mirroring the data from the volatile memory device to the multiple non-volatile storage devices includes:
utilizing direct memory access (DMA) channels for mirroring the data from the volatile memory device to the multiple non-volatile storage devices.

20. The method of claim 11, wherein the multiple non-volatile storage devices are solid-state drives.

21. A non-transitory computer-readable medium storing a set of instructions, the set of instructions comprising:
one or more instructions that, when executed by one or more processors of a memory system, cause the memory system to:
configure a volatile memory device as a storage device;
store data to the volatile memory device; and
mirror data from the volatile memory device to multiple non-volatile storage devices using an interleaving mirroring technique,
wherein the interleaving mirroring technique includes distributing the data across the multiple non-volatile storage devices such that different portions of the data are mirrored to different non-volatile storage devices, of the multiple non-volatile storage devices, and
wherein a respective size of each portion of the data, of the different portions of the data, corresponds to a respective cache size of a non-volatile storage device, of the different non-volatile storage devices.

22. The non-transitory computer-readable medium of claim 21, wherein the volatile memory device is a compute express link (CXL) compliant memory device, and
wherein the one or more instructions, that cause the memory system to configure the volatile memory device as the storage device, cause the memory system to represent the CXL compliant memory device as a storage block device on a peripheral component interconnect express root complex.

23. The non-transitory computer-readable medium of claim 21, wherein the one or more instructions further cause the memory system to perform a training operation to determine an optimal interleaving pattern associated with the interleaving mirroring technique.

24. The non-transitory computer-readable medium of claim 23, wherein the one or more instructions, that cause the memory system to determine the optimal interleaving pattern, cause the memory system to, for each non-volatile storage device, of the multiple non-volatile storage devices:
determine an optimal size of a cache memory for that non-volatile storage device; and
configure a block size for that non-volatile storage device such that the block size is equal to the optimal size of the cache memory.

25. The non-transitory computer-readable medium of claim 21, wherein the one or more instructions further cause the memory system to copy the data from the multiple non-volatile storage devices to the volatile memory device based on booting up the volatile memory device.
